(19) United States
(12) Patent Application Publication
(10) Pub. No.: US 2019/0279257 A1
(43) Pub. Date: Sep. 12, 2019

(54) SYSTEM AND METHOD FOR CLICKABLETV TARGETING BY LOCATION AND CONTENT ATTRIBUTES

(71) Applicant: Michael Stephen Kokernak, Boston, MA (US)

(72) Inventor: Michael Stephen Kokernak, Boston, MA (US)

(21) Appl. No.: 15/912,615

(22) Filed: Mar. 6, 2018

(51) Int. Cl. G06Q 30/02

(52) U.S. Cl. CPC G06Q 30/0273; G06Q 30/0277

(57) ABSTRACT

The present disclosure relates to system and method for clickableTV targeting by location and content attributes. An aspect of the present disclosure relates to system and method that receives an input requesting an advertisement for inclusion in a particular web page of a plurality of web pages that collectively represent a website, retrieves, upon clicking of the advertisement embedded in the particular web page, one or more web links that enables the user to view an advertised product, determine one or more interaction events performed by the user while viewing the advertised product, and generate a registration entry associated with the one or more interaction events. The input can include at least attribute information provided by an advertiser of the advertisement.

### FIELD OF THE INVENTION

The present disclosure relates generally to the field of advertisement, and more particularly, to system and method for clickableTV targeting by location and content attributes.

### BACKGROUND

The background description includes information that may be useful in understanding present invention. It is not an admission that any of the information provided herein is prior art or relevant to the presently claimed invention, or that any publication specifically or implicitly referenced is prior art.

The popularity of the internet makes it an attractive medium for advertising. Advertising on the internet can include placing banner ads, which are rectangular boxes that include graphic components, on a page viewed by a user. When a user selects an advertisement, e.g., by clicking on it, embedded hypertext links direct the user to the advertiser's web site. An advertiser can request that advertisements related to the advertiser's products and/or services be displayed on one or more web pages of one or more web sites. A publisher, e.g., a creator of a web site, can grant permission for advertisements to be displayed on web pages of their web site. The advertisements displayed on a web site can be tailored to meet the needs and interests of a user, which, in turn can be determined based on factors including the content displayed on the web site, user information, and the like. When a user visits a web site, the first web page displayed to the user can be the home page of the web site, which, in turn can be a login page. Subsequently, the user can navigate to other pages on the web site, e.g., by selecting hyperlinks that may be displayed on the home page. Each web page on a web site can be characterized by a page attribute, where the attribute is an indication of the type of the page. For example, the home page of a web site can have “homepage” as a page attribute.

Further, Interactive media (e.g., the Internet) has potential for better targeting of advertisements (“ads”). For example, some websites provide information search functionality that is based on keywords entered by the user seeking information. This user query can be used as an indicator of the type of information of interest to the user. By comparing the user query to a list of keywords specified by an advertiser, it is possible to provide some form of targeted advertisements to these search service users.

In addition to using keywords, some conventional online advertising solutions look at web page content to -improve target advertisements. For example, if a web page includes content related to sports, then sports-related advertisements can be targeted to that web page. While such conventional solutions can improve ad targeting, but these solutions do not match a user with a physical “brick and mortar” business located in the user's geographic region or a region of interest to the user. Nor do these conventional solutions present location based information in an interactive or exploratory manner.

Some conventional online mapping products provide users with business location information within a geographic region. Such mapping products often require the user to specify a search query. Such mapping products typically do not allow advertisers to reach users that are not interacting with the mapping product. Nor do these mapping products match ads to web page content.

Television media buying traditionally has been executed through a combination of total audience impressions and demographics. Companies like Coca-Cola buy tens of millions of audience impressions in nearly every media buy. The global advertiser uses readily available software to target those audience impressions by age, location, demographics, and financial income metrics. Coca-Cola will buy across many television networks to reach a specific audience goal that is measured by Nielsen Media Research. Nielsen Media Research, gathering audience impression data through set top boxes and people meters, will report to the networks (and Coca-Cola) the actual audience reaches of a television program. Coca-Cola will then adjust their purchase orders until all audience impressions have been met.

In recent years the television media buying industry has seen the emergence of addressable advertising to the home. What this means is that a specific thirty-second commercial can be inserted into an “addressed” or specific home. Therefore advertisers, like Coca-Cola, can buy television commercials through a shotgun approach by aggregating audience impressions and also fine tune parts of that same media buy in precise targeting (a rifle shot) into addressable homes. What emerges is a blended approach of shotgun and rifle shot targeting for television advertising. Since the advertiser has little control over who watches through audience impressions the CPM (cost per thousand) is typically much lower than the addressable media buy CPM.

Accordingly, given the extensive consumer acceptance and widespread interest in such advertisements or multimedia contents, there is always a need for better ways to commercialize the economic value generated from these advertisements or multimedia contents. Also, advertisers are particularly worried in using new technologies that do not provide the most secure methods available to protect their customer data. Furthermore, their s also a need to provide an automated way or mechanism to track or monitor the advertisements from advertisers point of view.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### SUMMARY

The deficiencies described above are overcome by the disclosed implementations of system and method for clickableTV targeting by location and content attributes.

In one example, an advertiser can specify attributes of one or more web pages on which their advertisements can be displayed. If the attribute of a web page matches the attribute specified by the advertiser, then the advertiser's advertisement may be displayed on the web page. A publisher of a web site can request that advertisements be displayed on one or more web pages of their web site when a user accesses the web page. Based on the page attribute of the web page that the user accesses, one or more advertisements can be transmitted to the user for display, where the advertisements are chosen such that the page attribute matches the attribute specified by the advertiser.

Accordingly, in an aspect of the present disclosure relates to a computer-implemented method that receives an input requesting an advertisement for inclusion in a particular web page of a plurality of web pages that collectively represent a website, retrieves, upon clicking of the advertisement embedded in the particular web page, one or more web links that enables the user to view an advertised product, determine one or more interaction events performed by the user while viewing the advertised product, and generate a registration entry associated with the one or more interaction events.

In an aspect, the input can include at least attribute information provided by an advertiser of the advertisement.

In an aspect, the attribute information specifies specific criteria for advertisement, the specific criteria comprising: locations, countries, media outlets, shows, actors, age groups, community, gender, genre, type of advertisement, income group, status, cable network lists, show lists, market lists, MVPD lists, and network lists and time of a day.

In an aspect, the method can display the particular web page with the selected advertisement on a device at a network location.

In an aspect, the advertisements are embedded in the form of one or more clickable moments, and wherein the attribute information is associated with one or more clickable moments.

In an aspect, the at least attribute information provided by the advertiser of the advertisement is indicative of a targeted advertising.

In an aspect, the advertiser pay's only for clicks or revenue-sharing according to agreements pre-defined.

In an aspect, the clicking of the advertisement enables retailing of the advertised product.

In an aspect, the registration entry is preferably stored on decentralized blockchain ledgers. In another aspect, the registration entry is secured using a combination of one or more tokens and one or more encryption keys ensuring privacy and security of the user's data and an advertiser's data.

In an aspect, the advertisement enables the user to request information associated with the advertised product from the advertiser.

In an aspect, the advertisement embedded in the particular web page is configured to operate in a LIVE environment and/or a desktop virtual reality (DVR) environment.

In an aspect, the one or more interaction events are associated with at least a click stream data.

In an aspect, the one or more interaction events are associated with at least an e-commerce sales data.

An aspect of the present disclosure relates to a system having one or more computers and one or more storage devices storing instructions that are operable, when executed by the one or more computers, to cause the one or more computers to perform operations. The operations can receive an input requesting an advertisement for inclusion in a particular web page of a plurality of web pages that collectively represent a website, retrieve, upon clicking of the advertisement embedded in the particular web page, one or more web links that enables the user to view an advertised product, determine one or more interaction events performed by the user while viewing the advertised product, and generate a registration entry associated with the one or more interaction events.

In an aspect, the input can include at least attribute information provided by an advertiser of the advertisement.

An aspect of the present disclosure relates to non-transitory computer-readable medium storing software comprising instructions executable by one or more computers which, upon such execution, cause the one or more computers to perform operations.

The operations can receive an input requesting an advertisement for inclusion in a particular web page of a plurality of web pages that collectively represent a web site, retrieve, upon clicking of the advertisement embedded in the particular web page, one or more web links that enables the user to view an advertised product, determine one or more interaction events performed by the user while viewing the advertised product, and generate a registration entry associated with the one or more interaction events.

In an aspect, the input can include at least attribute information provided by an advertiser of the advertisement.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates an exemplary user interface of the proposed system for clickableTV targeting by location and content attributes, in accordance with an exemplary embodiment of the present disclosure.

FIG. 2 illustrates an exemplary tracking/follow of money using the proposed system for clickableTV targeting by location and content attributes, in accordance with an exemplary embodiment of the present disclosure.

FIG. 3 illustrates an exemplary transaction flow of the proposed system for clickableTV targeting by location and content attributes, in accordance with an exemplary embodiment of the present disclosure.

FIG. 4 illustrates an exemplary computer system 400 in which or with which embodiments of the present invention may be utilized.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

In an implementation, one or more computing device(s) used herein may be any of a variety of types of computing device, including without limitation, a desktop computer system, a data entry terminal, a laptop computer, a notebook computer, a tablet computer, a handheld personal data assistant, a smartphone, a body-worn computing device incorporated into clothing, a computing device integrated into a vehicle (e.g., a car, a bicycle, etc.), a server, a cluster of servers, a server farm, etc.

In various embodiments, a computing device used herein can comprise a storage storing a control routine, a processor circuit, controls, a display, and a link interface for various uses of the proposed system including, without limitation, running application programs and communicating with various networks and devices such as the Internet and beacon devices. It is envisioned that some computing devices are likely to be relatively portable computing devices able to be carried on the person of its operator (e.g., a smartphone, a personal data assistant (PDA), a tablet computer, a watch or wearable computer, etc.). It is therefore further envisioned that the links formed between the various computing devices used herein is likely to be a wireless or a wired link.

The link may be based on any of a variety (or combination) of communications technologies by which signals may be exchanged, including without limitation, wired technologies employing electrically and/or optically conductive cabling, and wireless technologies employing infrared, radio frequency or other forms of wireless transmission. It is envisioned that one or more of these links may be implemented as channels of communication (e.g., virtual private network (VPN) channels or other forms of virtual channels) formed between computing devices through portions of the Internet.

Generally, and in various embodiments, the link will use signaling and/or protocols conforming to any of a variety of industry standards, including without limitation, RS-232C, RS-422, USB, Ethernet (IEEE-802.3) or IEEE-1394. Alternatively or additionally, where one or more portions of the link employ wireless signal transmission, one or more of the interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

The computing devices may store instructions to be executed by processor in storage, such as control routine. The storage may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. As such, and in various embodiments, storage may provide volatile and/or nonvolatile storage of data, data structures, computer-executable instructions, and so forth. For example, a number of program modules can be stored in memory units, including an operating system, and control routine.

The processor circuit may be caused by control routine to initiate a registration process. During the registration process, a user is prompted for various pieces of personal information concerning the user such as a name, an address, contact information, account information, etc. The user may also be prompted to choose whether to opt-in, and if so, to which kinds of messages.

In an aspect, the proposed system (interchangeably termed as system herein) can be operatively configured as a website accessible by any Internet enabled computing device, and can as well be configured as a mobile application that can be downloaded on a mobile device that can connect to Internet. In such manner, the proposed system can be available 24*7 to its users. Any other manner of implementation of the proposed system or a part thereof is well within the scope of the present disclosure/invention. The computing device can be a PC, a tablet, a smart phone and other like devices.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

“TV Stations” broadcasters that have the rights to broadcast on a local cable system. Typically the broadcaster has come to agreement with the MVPD, including DirecTV and Dish Network, for its transmission on the system. TV stations will also come to agreement on the revenue sharing for the ClickableTV enhancements that are passed through the ClickableTV server from the local cable companies.

“Local Cable” the local cable systems of the MVPD (multi video program distributor). Typically the local cable company has the rights to insert two minutes per hour into cable networks. In addition, the MVPD will (under contract) enable TV stations and networks for ClickableTV.

“Network” a network contains many television shows. The network has an agreement with the MVPD companies. As part of the extension of the network copyright license the network typically is paid on a per subscriber basis from the MVPD provider. In return the MVPD provider charges each subscriber on the cable system to watch the programming. In much the same fashion the network and MVPD provider will come to agreement on the per click revenue distribution. The terms of the revenue split will be stored in the ClickableTV application and applied for each media buy. Either party will have the ability to override the stored per click distribution rate as long as both parties agree to any adjustment. The same function will also apply to broadcast stations.

“Syndication” Syndication are standalone TV shows that are nested in broadcast and cable networks. Typically a syndication show will retain 60% to 80% of the commercial inventory that they have the rights to sell to advertisers. The retention of the commercial inventory is the compensation the show receives from the networks. The syndication shows will have the right to sell enhancements on the commercials that fall within its inventory. In addition the networks will have the right to sell enhancements in its inventory. Both parties will need to come to agreement on the per click rate before the enhancement is carried over into the ClickableTV server.

In one example, an advertiser can specify attributes of one or more web pages on which their advertisements can be displayed. If the attribute of a web page matches the attribute specified by the advertiser, then the advertiser's advertisement may be displayed on the web page. A publisher of a web site can request that advertisements be displayed on one or more web pages of their web site when a user accesses the web page. Based on the page attribute of the web page that the user accesses, one or more advertisements can be transmitted to the user for display, where the advertisements are chosen such that the page attribute matches the attribute specified by the advertiser.

Accordingly, in an aspect of the present disclosure relates to a computer-implemented method that receives an input requesting an advertisement for inclusion in a particular web page of a plurality of web pages that collectively represent a website, retrieves, upon clicking of the advertisement embedded in the particular web page, one or more web links that enables the user to view an advertised product, determine one or more interaction events performed by the user while viewing the advertised product, and generate a registration entry associated with the one or more interaction events.

In an aspect, the input can include at least attribute information provided by an advertiser of the advertisement.

In an aspect, the attribute information specifies specific criteria for advertisement, the specific criteria comprising: locations, countries, media outlets, shows, actors, age groups, community, gender, genre, type of advertisement, income group, status, cable network lists, show lists, market lists, MVPD lists, and network lists and time of a day.

In an aspect, the method can display the particular web page with the selected advertisement on a device at a network location.

In an aspect, the advertisements are embedded in the form of one or more clickable moments, and wherein the attribute information is associated with one or more clickable moments.

In an aspect, the at least attribute information provided by the advertiser of the advertisement is indicative of a targeted advertising.

In an aspect, the advertiser pay's only for clicks or revenue-sharing according to agreements pre-defined.

In an aspect, the clicking of the advertisement enables retailing of the advertised product.

In an aspect, the registration entry is preferably stored on decentralized blockchain ledgers. In another aspect, the registration entry is secured using a combination of one or more tokens and one or more encryption keys ensuring privacy and security of the user's data and an advertiser's data.

In an aspect, the advertisement enables the user to request information associated with the advertised product from the advertiser.

In an aspect, the advertisement embedded in the particular web page is configured to operate in a LIVE environment and/or a desktop virtual reality (DVR) environment.

In an aspect, the one or more interaction events are associated with at least a click stream data.

In an aspect, the one or more interaction events are associated with at least an e-commerce sales data.

An aspect of the present disclosure relates to a system having one or more computers and one or more storage devices storing instructions that are operable, when executed by the one or more computers, to cause the one or more computers to perform operations. The operations can receive an input requesting an advertisement for inclusion in a particular web page of a plurality of web pages that collectively represent a website, retrieve, upon clicking of the advertisement embedded in the particular web page, one or more web links that enables the user to view an advertised product, determine one or more interaction events performed by the user while viewing the advertised product, and generate a registration entry associated with the one or more interaction events.

In an aspect, the input can include at least attribute information provided by an advertiser of the advertisement.

An aspect of the present disclosure relates to non-transitory computer-readable medium storing software comprising instructions executable by one or more computers which, upon such execution, cause the one or more computers to perform operations.

The operations can receive an input requesting an advertisement for inclusion in a particular web page of a plurality of web pages that collectively represent a web site, retrieve, upon clicking of the advertisement embedded in the particular web page, one or more web links that enables the user to view an advertised product, determine one or more interaction events performed by the user while viewing the advertised product, and generate a registration entry associated with the one or more interaction events.

In an aspect, the input can include at least attribute information provided by an advertiser of the advertisement.

In an aspect, a video (also interchangeably referred to as “multimedia content” which can include any or a combination of different content forms such as text, audio, images, animations, video and interactive content) is provided that includes a clickable link. Upon activation of the link, a graphical interface is provided for viewing an advertised product and/or for the activation of one or more tokens (cryptocurrencies) to purchase/buy the advertised product. The graphical interface is pre-populated with an address for the video and a keyword associated with the video.

As examples, the clickable link may include the keyword. The keyword may be a hashtag. The keyword may be preceded by a # symbol. The video may be displayed on FunnyorDie or YouTube or as an advertisement on TV. The advertised product may be displayed any online food and grocery store. The clickable link may direct the use to an online food and grocery store or an advertiser's dedicated web site where a user can buy the advertised product. The clickable link may cover a portion of the video. The clickable link may be activated by clicking on the link using a pointing device. The clickable link may be activated by clicking on the video using a pointing device. The graphical interface may be pre-populated according to: address #keyword; where address is the address for the video, and keyword is the keyword associated with the video. The keyword may be searchable.

In an aspect, a video according to the present disclosure includes an embeddable keyword link that facilitates consistent keyword usage across social media or normal English postings. In an example, a keyword link may be embedded into the video itself, such that when the video or a portion of the video is clicked (e.g., the portion of the video that includes the keyword acts as a link), a graphical interface for generating a advertised product posting may be provided that is pre-populated with certain data such as a keyword associated with the video.

In an aspect, a link may be embedded into a video using a variety of mechanisms. For example, certain websites provide functionality for incorporating links into a video (e.g., LinkedTube.com). By entering data related to the video and the link, code may be generated that facilitates embedding of the video into a webpage with the embedded keyword link. The entered data may include the address of the video, the content to be displayed on the video for the link (e.g., the hashtag or keyword), and the address to which the user should be directed when clicking on the link (e.g., the social media or advertised products graphical interface that is pre-populated with the video address and the embedded keyword). Other video hosting services, such as YouTube, may offer similar functionality for embedding links into videos.

In an aspect, the registration entry is generated based on the one or more interaction events. In another aspect, the registration entry is secured using a combination of the one or more tokens and one or more encryption keys ensuring privacy and security of the user's data and an advertiser's data.

Many embodiments of the present invention include a decentralized, distributed digital ledger that documents the transfer (also called licenses) from creators to end-users (also called licensees, users, end users or consumers) and/or between end users, referred to here as a blockchain ledger. In many embodiments, the ledger is stored, modified and maintained on several independent nodes and trust is established by rules on the format on the ledger rather than the source and origin of the information. In such embodiments, the rules are established with cryptographic principles that make modification of the data difficult. In further embodiments, no centralized third party of trust is needed for transactions involving license distribution, selling, data-tracking, metrics analytics, and/or auditing. In many embodiments, content creators (or copyright owners) are motivated to verify and confirm past licenses, document and log transactions, and solve challenges which provides the right to register a new creation (also called work, asset or content) in the blockchain ledger in return. In certain embodiments, creations include, but are not limited to, text, images, audio, and video, but can also include any licensable work that can be represented in digital form. A copy of a creation may be referred to as a piece of content. In many embodiments, a blockchain ledger having a record of a creation evidences that a creator created a media work and additional transactions in the blockchain ledger can provide a right for a user account or playback device to access and/or play back a piece of content that is a representation of that creation.

In a number of embodiments, the blockchain ledger is stored and verified in a decentralized fashion, i.e. replicated to different entities (that may be referred to as nodes) that are separately able to verify past transactions. In further embodiments, the ownership of a creation as well as license can be proven using cryptographic principles. In many embodiments, the chaining of transactions, cryptographic verification and the hash challenge utilizes a block chain system based on principles and/or mechanisms similar to those in the art of cryptocurrency. Techniques for managing blockchains in the context of currency are described in “Bitcoin: A Peer-to-Peer Electronic Cash System” by Satoshi Nakamoto, published in 2008, the disclosure of which relevant to blockchain management is hereby incorporated by reference in its entirety.

A block chain can typically be understood to be a distributed database that maintains a continuously-growing list of records called blocks. Each block contains a link to a previous block generated using a hash of the previous block, and often includes mechanisms for protection from tampering and revision. The block chain is distributed so that copies are replicated among participating nodes in the system. As transactions are added the copies are extended and the longest chains are trusted that follows a rule and provides according proof of work or stake. Nodes may be any of a variety of hardware devices or playback devices, such as, but not limited to, servers, workstations, desktop computers, mobile devices, and/or tablets, configured to participate in the decentralized digital system as discussed further below. More specifically, nodes can include blockchain management devices and playback devices as described in greater detail further below.

In some embodiments, pieces of content are interpreted and used with a platform (which can be a playback device, viewer, app, application, client or decoder as will be discussed further below) that can play back many forms of media using a player application. In certain embodiments, identifying the platform can be an important tool to limit piracy of assets by using encryption and/or other mechanisms that can limit creations to specific platforms. The creator of the work can authorize (e.g., by cryptographically linking) specific platforms to a creation by registering it in the blockchain ledger. In many more embodiments, the blockchain ledger may be utilized to enable a platform to verify and enforce limitations or usage rules imposed on the content by the license such as (but not limited to): limiting the number of playbacks, limiting the transfer of the license, and limiting the length of time allowed for a playback to occur.

Usage rules may be determined by the creator by issuing usage rules and/or limiting approved platforms. In yet additional embodiments, licensing and other transactions can be accompanied with financial transactions for purchase on another platform, including cash, credit card, Bitcoin or any of a variety of other forms of electronic payment system. The financial transactions can be independent of the registration and execution of the ledger. Alternatively bitcoin transactions can be referenced from the ledger or smart contracts can bind payment and licensing. Systems and methods for performing quality based streaming of content in accordance with various embodiments of the invention are discussed further below.

In an exemplary embodiment, a decentralized digital ledger system can allow creators to increase control of their content, reduce transaction costs and friction, i.e., the ability to get to market faster and with less cost. This can be accomplished by removing the need for middlemen distributors, subscriber management systems, centralized and proprietary management systems, network infrastructure, etc. A decentralized digital ledger system for management can increase revenue and payment security for content owners across a fragmented pool of operators and solutions. The decentralized digital ledger system can allow for a “publish-once” methodology, eliminating the need for walled gardens of content and payment solutions. The ledger system can also help establish intellectual property by creating an exact and virtually immutable record that can show a work's registration date and rightful owner. Additionally, due to the fact that the smart contracts in the ledger do not need to be limited by legal and geographical boarders the ledger allows content creators to license works globally and the system can be used where there may not be a proper payment system or trusted agent to facilitate a standard licensing transaction. Due to the static and public nature of a ledger block chain, creators can easily calculate proper royalty payments, as well as track additional marketing data.

In many embodiments, the system has a further benefit of being pseudonymous, i.e., the content transaction cannot be traced to an individual or location but a pseudonym (key) and are therefore protecting consumer's privacy.

In an exemplary embodiment, the decentralized digital ledger system can include a blockchain management device that can communicate with one or more other nodes via a network. Additionally, the decentralized digital ledger system includes a variety of playback devices that may run on hardware such as personal computers, set-top boxes, mobile phones, personal computing devices, some of which may communicate on the network via a wireless access point.

In an exemplary embodiment, the decentralized digital ledger system can include a blockchain management device configured to create an initial genesis block in a ledger file. This new ledger file may be transmitted over the network to other nodes including playback devices and other blockchain management devices. In many embodiments, the decentralized digital ledger system is decentralized in that entire copies of a particular ledger file are stored on multiple nodes. In other embodiments, some copies may be a pruned copy of the ledger file. Participating nodes may utilize a copy of the ledger and make the transaction history available for download to others per default via network such as by utilizing peer-to-peer protocols.

Content creations that have been registered and licensed in the ledger may be distributed to playback devices for immediate or later playback. Certain playback attributes and other license restrictions may be stored in a playback device's local memory. In additional embodiments, certain license restrictions like playback count and license expiration may be utilized by the playback device to limit playback without having to be updated in the ledger.

For decentralized currencies the aim often is to limit minting of new coins over time, in order to control the number of coins getting into circulation per interval to limit inflation. To control the interval, the challenge to solve is adjusted to the applied processing power, i.e. increase of difficulty as a reaction to a quicker solution. The decentralized digital ledger system typically is not limited in this way as inflation is not a concern. Instead, a more active system with more users and miners can create more issued per time. Hash challenge difficulty would likely not have to vary much except for possible increases to maintain security due to increased computing power. In this sense, the control of inflation can be different from a currency system because the issuing of a number of additional different works does not typically devalue other creations that have already been registered, unlike with currency.

In several embodiments, the right or ability to register a media work into the block chain ledger is represented by a work registration token that is earned by finding solutions to a hash challenge (e.g., the hash challenge required to close a block). Each solution may reward the solver with work registration tokens, where the number of tokens (RN) granted per solution is configurable as an aspect of regulating the rate at which works can be registered into the blockchain ledger. The reward can be a single token, fraction thereof, or multiple.

For example, if the frequency at which solutions are being found should be decreased, the number of tokens RN granted can be increased allowing more works to be registered with less work, resulting in less mining and a lower frequency. If the frequency at which solutions are being found should be increased, the number of tokens RN granted can be decreased

Similar to the hash challenge in bitcoin the adjustment can be automated by changing it in accordance with a targeted frequency of closing a block. A higher frequency will have more overhead but is quicker to secure the transactions, which is important to verify a license transfer for immediate consumption or play count validation. It can also depend on the length of a typical asset where the verification of a feature film with 15 minutes may be acceptable.

In several embodiments, this can be an alternative to adjusting the difficulty of the hash challenge itself. A work registration token may be represented as a unique value and associated with a private key holder by publishing the public key. One token grants the ability to register one work into the blockchain ledger. Fractional tokens can be combined and a combination of token quantities resulting in more than one result in a residual token quantity that can be used to issue other. This is similar to combining bitcoin transaction values to match a desired transaction value.

In a number of embodiments, parallel ledger systems may exist and either work together or be indexed alongside each other. The licensed creations may not be interchangeable and devices could look into several different databases for works based on a number of filters including, but not limited to, creations from similar regions, different content owners, and/or creation times. The decentralized ledger may work with external web services or individual clients to provide information about the ledger including, but not limited to, creation contents, recommendations, ratings, and discovery.

Where discussions herein may refer to an owner, creator, or user performing certain actions with respect to a digital ledger or processes involving digital ledgers, one skilled in the art will recognize that such actions may be performed by and through a device such as a workstation, desktop computer, mobile device, laptop, tablet, and/or playback devices such as those discussed above. Various devices that participate in a decentralized digital ledger system may be referred to as nodes. Further, these actions may be conducted in processes such as those discussed further below and implemented by processors configured by applications stored in memory to perform all or part of those processes. While a variety of decentralized digital ledger systems are described, the specific components utilized within a decentralized ledger system and the manner in which ledgers are stored and maintained may vary in accordance with the requirements of specific applications. Blockchain management device systems that can be utilized in decentralized digital ledger systems in accordance with various embodiments of the invention are discussed further below.

In an exemplary embodiment, a blockchain management device that can be used to create and/or modify a decentralized digital ledger in accordance with embodiments of the invention. The blockchain management device can includes a processor, network interface, network input/output, system bus, and memory. Memory includes a ledger creation application, ledger modification application, and ledger block closing application.

A decentralized digital ledger system may also include additional blockchain management devices with components similar to blockchain management device. While a specific architecture of a blockchain management device is discussed, blockchain management devices in accordance with embodiments of the invention may utilize any of a variety of architectures as appropriate to the particular application. Content playback devices that may utilize a digital ledger in accordance with embodiments of the invention are discussed above.

In an exemplary embodiment, a playback device is a platform that can be used to enforce restrictions mandated by the creator of a piece of content (a media work) and encoded in the blockchain and play the content in accordance with the restrictions. In addition, granting the playback device the ability to play back a particular piece of content by a creator can include a requirement and determination that this playback device or category of playback device is capable of playback of the piece of content. It can also represent a public promise that this platform and piece of content can be combined, given the proper license.

Playback devices may be used to display and consume different media types, including, but not limited to: audio (Stereo, Multi-channel Surround), video (2-Dimensional, 3-Dimensional) Augmented Reality (AR), and/or Virtual Reality (VR), text, images, metadata, and applications, but may also be extended to digital titles that certify ownership in other things, such as real estate properties, art and intellectual property. The manifestation of the right can be converted into a digital asset, e.g., such as by being scanned and digitally signed that is used as the digital assets the license is assigned to.

A platform may be a software playback application or a hardware device incorporating a software playback application. In a number of embodiments a platform is identified by a hash performed over the executable code of the software program that facilitates playback and/or ledger modification. In other embodiments, other characteristics of a software application or hardware device and/or information stored on a hardware device can be utilized to generate an identifier or hash of the platform. Playback of a piece of content may be enabled by a key that entitles a specific software version, or by a generalized platform key that enables only a group of device versions. In this case the creator trusts another entity (such as a company developing a software media player) to conform to requirements. This trust may be established with legal agreements, standards (that prescribe robustness rules as described above) and/or from reputation. In several embodiments of the invention the platform license cannot be revoked, in order to guarantee an immutable connection with the platform that a licensee can exercise and to foster trust by the consumer that the ability to use the content is long lasting. However, in further embodiments, if the security of the platform becomes compromised however, future assets may impose different requirements.

In still further embodiments, the platform may enforce license terms that are not registered in the ledger and agreed on with the platform or creator. However, they don't need to be standardized for all participants in the system, although a de-facto standard is helpful to foster adoption. In still further embodiments, certain license terms may not necessarily be registered in the ledger but are part of the player limitations. For example, enabling HDCP during playback or using a secure video path including a trusted execution environment can be restrictions inherent to the player.

In further still embodiments, a pruned blockchain ledger is stored on the playback device instead of the entire chain of blocks referencing all the way back to the genesis block. The use of pruned blockchain allows for fast loading and processing times, especially during a verification step that examines the trail of ownership of a creation from the first registration until the current potential transaction. A blockchain can be pruned by removing transactions that are no longer relevant and/or required, such as play count transactions (excluding the most recent), license transfer transactions (excluding the most recent), and/or expired licenses. If removing transactions changes a block's hash solution, any link to that block may need to be regenerated.

While a variety of playback device systems are described above, other playback devices incorporating any of a variety of architectures and/or hardware enabling the utilization of a decentralized digital ledger system in accordance with various embodiments of the invention. For example, in certain embodiments, a copy of the ledger may be stored locally in the playback device and utilized when the playback device has no connection to other nodes in the ledger system. These periods are typically limited to enforce connection to the latest updated ledger.

In many embodiments, a distributed network of blockchain management devices and playback devices process and synchronize the block chain by consensus across multiple POPs (points of presence) across geographic regions or globally. The devices may respond to queries from other devices in the network in a peer-to-peer nature to validate entitlement of users, devices and/or content. In further embodiments, operators of blockchain management devices may be paid or offered credit towards various services, monetarily through a universal currency, or other incentives that could be used for rewards such as, but not limited to, purchasing of content from the content owners associated with this network. Payment may be conducted using the device or a secondary mechanism, such as through a payment service like PayPal or Bitcoin. In many embodiments, the processing or mining of block chain solutions done by a blockchain management device yields the right to register and license a creation instead of a direct monetary reward.

In an exemplary embodiment, a fundamental structure of a decentralized blockchain ledger includes blocks which are linked together to form a blockchain. Each block in the blockchain contains a reference to the previous block in the chain, with the exception of the genesis block which is the first block created and contains no reference. Ledger blocks contain similar components but may vary in size due to the amount of transactions that are recorded within each block. In a number of environments, the block size can exceed one megabyte.

In additional embodiments, assets in a block chain are represented by a hash (sometimes referred to as a cryptographic hash), or output of another data operation that is difficult to reverse to recover the input even when the output is known, and would be virtually unique to each creation being registered. The use of a database listing meta data of creations with their respective hashes can aide in the search for creations in the block chain. In certain embodiments, this database is stored within the block chain itself. In certain other embodiments, the database is stored externally from the block chain and referenced by methods including, but not limited to, links to other blocks in different block chains, hard drive sector locations, and/or URL addresses.

In still further embodiments, meta data relating to the registered creation can be identified in the registration itself such as, but not limited to, cover art for movies, artist information for music, URL links to download the content, and/or methods that allow for the unlocking of potential future content.

In an exemplary embodiment, transactions represent various types of restrictions and operations concerning a media work and can be stored in a block as entries, each having a transaction identifier (ID). As will be discussed further below, one or more transactions may be grouped for entry into a block before the block is closed. Where a description below indicates that a user or creator enters a transaction, the transaction may be entered by a device or node in the decentralized digital system controlled by that user or creator. A transaction may be digitally signed using a private key over all or a portion of the contents of the transaction.

Transactions that are transmitted and distributed in the network are added to the block. Many potential actions may be represented as a transaction that can be recorded in the ledger as described further above. Some of these transactions include, but are not limited to, issuing of a license, sub-licensing or a creation, and/or platform enablement, play count, verification of ownership of a license. Many embodiments include registering a media work into the blockchain as a transaction. In further embodiments, the creator signs a transaction that identifies the asset issued by this creator, the playback device, external license, and/or license conditions and makes this public in the ledger. In several embodiments, the signing key is the same key as used for the creation of the asset or others enabled by that key to allow sub-licensing. Sublicensing enables another public key to issue licenses. The issuance is then public and can be tracked and billed additional sublicense restrictions could be included in or referenced by the ledger in order to limit the amount and frequency with smart contracts that match agreements between the creator and licensee. Sublicenses could be video distribution operators, including cable, IPTV, satellite and internet platforms that manage, distribute a stream of digital assets, including entertainment content. The signing ensures cryptographically that the creator is the only one issuing granting direct to the work or enabling others. In several embodiments, the public key matching the private signing key is also securely published in the ledger.

Another potential type of transaction is a transfer which occurs when one licensee transfers their license to another person using the decentralized ledger. In many embodiments, implementation of different licensing models is available including, but not limited to: sale, rental, pay-per-view, and/or re-sale of individual licenses for second-hand markets. In a number of embodiments, there are limits placed on the amount of transactions allowed which may simulate a more marketplace style of environment.

In still further embodiments, the ledger that is designed to act as a locker for digital assets may also include relevant transactions with existing ledgers, including other currency block chains. The benefits of such a system are to enable an easier start and penetration of the system as the decentralized ledger can participate in an existing updated system that already has regular issuing of blocks and distributed consensus on a time stamping service. In yet still further embodiments, to include the decentralized ledger with another block chain, the transactions can be hashed and the hash included in the other ledger and documented fully elsewhere. This location can be found using the hash in a public database or specified separately using a URL (uniform resource locator) included in the transaction.

Accordingly in an exemplary embodiment, the ClickableTV technologies bring a third media buying approach to the television advertising industry. While the audience impressions and addressable buying approach are grounded in Nielsen Media Research audience ratings the ClickableTV approach is quantified in the action the viewer took.

In some cases the advertiser, like Coca-Cola, may wish to only offer the clickable enhancement to a subsection of audience impression or addressable homes. This means that ClickableTV brings a third audience metrics to television advertisers by its ability to be enabled in specific locations, media outlets, networks, shows, and actors (but not limited).

Some advertisers may wish to have all their television advertisements enhanced with ClickableTV and by default they will select “ALL” for locations and media outlets. In other instances Coca-Cola may wish to only enable ClickableTV enhancements in a location or a particular television show. Keep in mind that Coca-Cola is setting its ‘per click’ rate for every time the viewer clicks on the television commercial in a TV Everywhere, SVOD, or vMVPD viewing environment.

When the clickable moment is executed the response data will be collected by Across Platforms. The advertiser may wish to combine the viewer response data with audience addressable and impressions data to get a clear picture over who is most engaged with their television commercial. Across Platforms will provide exportable technologies for the response data. The advertiser may use the ClickableTV media buying portal to finally tune future campaigns from the following criteria's—Country, TV Market, Daypart, Show Genre, Broadcast TV Station, Network, Show Name, Actor and others.

What this means is that upon selecting the targeting perimeters of the ClickableTV media buying portal anytime that a television commercial is included within that criteria it will be enhanced and will be clickable with respondent data captured. If the television commercial is outside those criteria then no enhancement will occur.

The advertiser should be able to select globally from the cable network lists, show lists, market lists, MVPD lists, and network lists to add these selections to the campaign targeting. Advertisers will be able to rebook successful ClickableTV media buys within the portal.

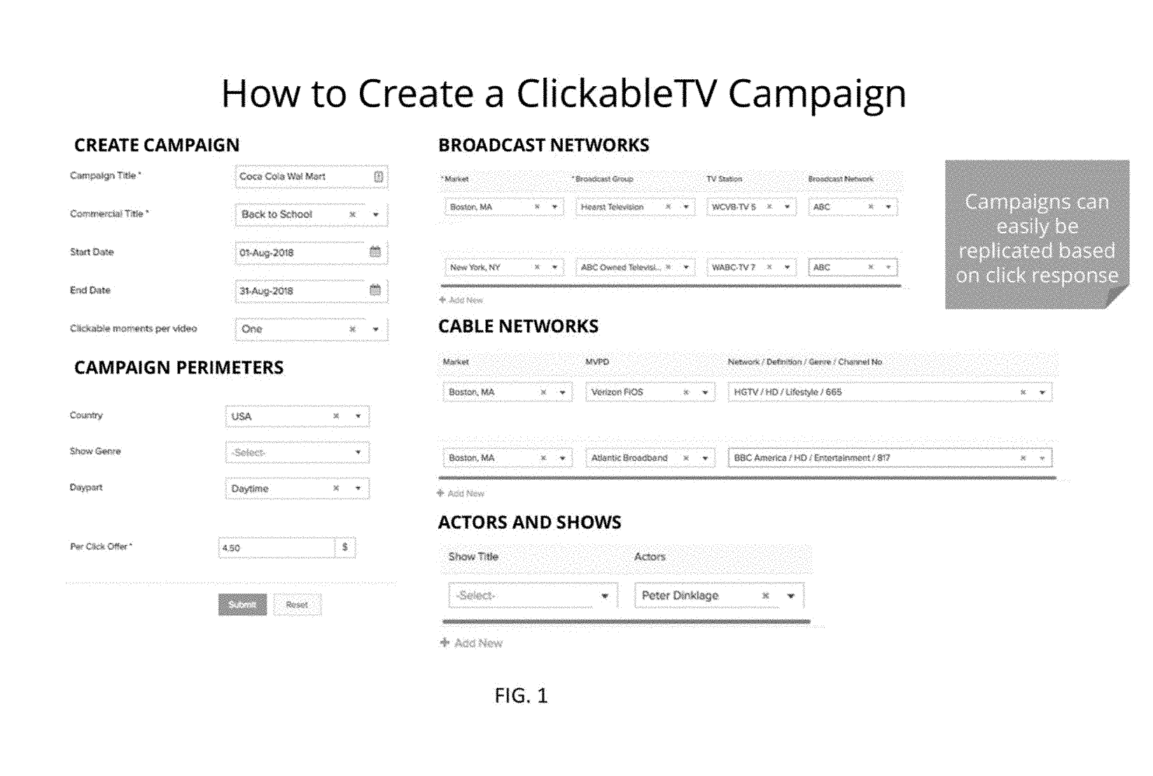

FIG. 1 illustrates an exemplary user interface of the proposed system for clickableTV targeting by location and content attributes, in accordance with an exemplary embodiment of the present disclosure.

In an embodiment, FIG. 1 only and many variations of the presentation of the functionality described herein may be substituted. However, components such as the clickableTV targeting by location and content attributes preferably implement a user interface such as the illustrated user interface to allow advertiser control of advertiser search listings. The illustrated functionality may be implemented in one or more software code routines or applications operating on a processing device associated with a database and server system or other device.

FIG. 1 is a screen shot of one embodiment of a ‘campaigns Interface Page’ wherein the heading ‘campaign title’ is selected because the user is at the junction. Under this interface page, an advertiser can select a campaign title either pre-defined using a dropdown menu or a new one. This interface page displays a plurality of options, such as but not limited to, ‘commercial title’, ‘start date’, ‘market’, ‘broadcast group’, ‘TV stations’ etc. Each of the plurality of options has one or more selectable and/or editable sub-option which may be selected and/or edited by the user.

In an exemplary embodiment, the interface can also include a plurality of campaign perimeters options. In an example, the campaign perimeters options can include, but are not limited to, specific criteria for advertisement. The specific criteria includes locations, countries, media outlets, shows, actors, age groups, community, gender, genre, type of advertisement, income group, status, cable network lists, show lists, market lists, MVPD lists, and network lists and time of a day.

In an exemplary embodiment, the campaigns Interface Page can also provide a mechanism to provide rate/charges for per click of advertisement or may provide offer to the publishers or end users.

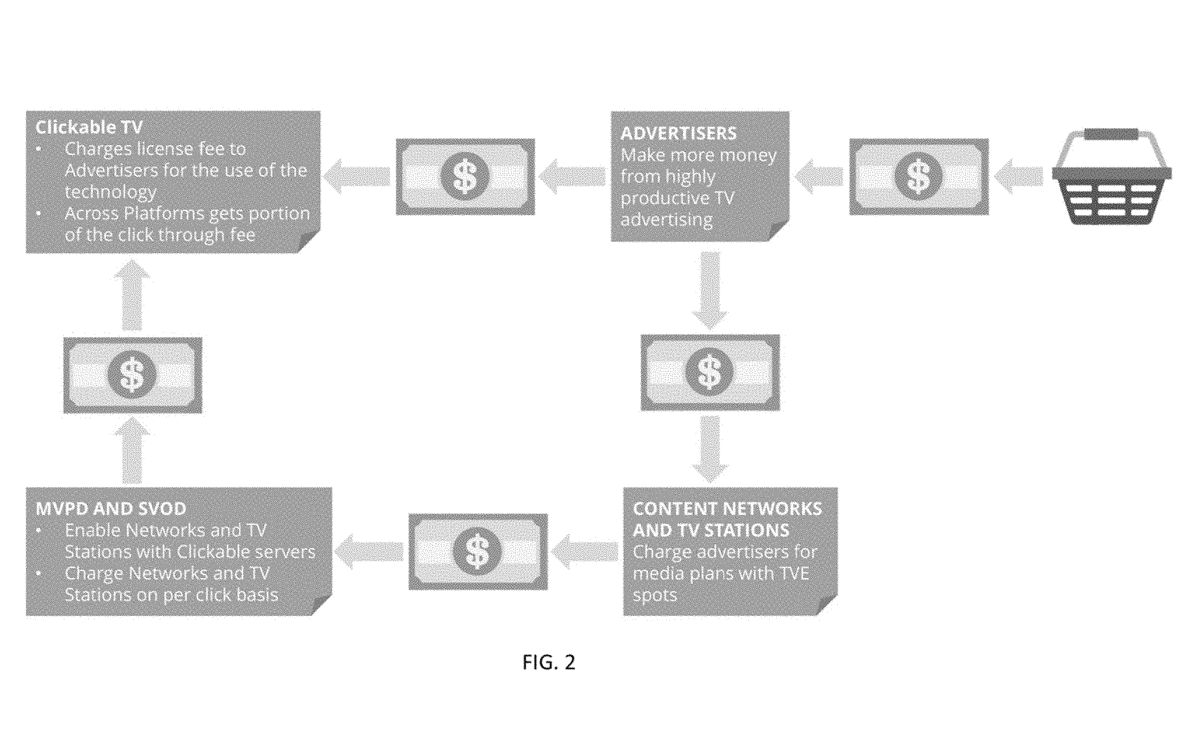

FIG. 2 illustrates an exemplary tracking/follow of money using the proposed system for clickableTV targeting by location and content attributes, in accordance with an exemplary embodiment of the present disclosure.

In an exemplary embodiment, as shown in FIG. 2, the embodiment provides various options to track/follow of money. The options may be distributed across and can include, but are not limited to, clickableTV, Advertisers, MVPD and SVOD, and content networks and TV Stations.

In an exemplary embodiment, clickableTV can charges license fee to Advertisers for the use of the technology, and gets portion of the click through fee. The advertisers can make money from highly productive TV advertising. The content networks and TV Stations can Charge advertisers for media plans with TVE spots. The MVPD and SVOD Enable Networks and TV Stations with Clickable servers and Charge Networks and TV Stations on per click basis.

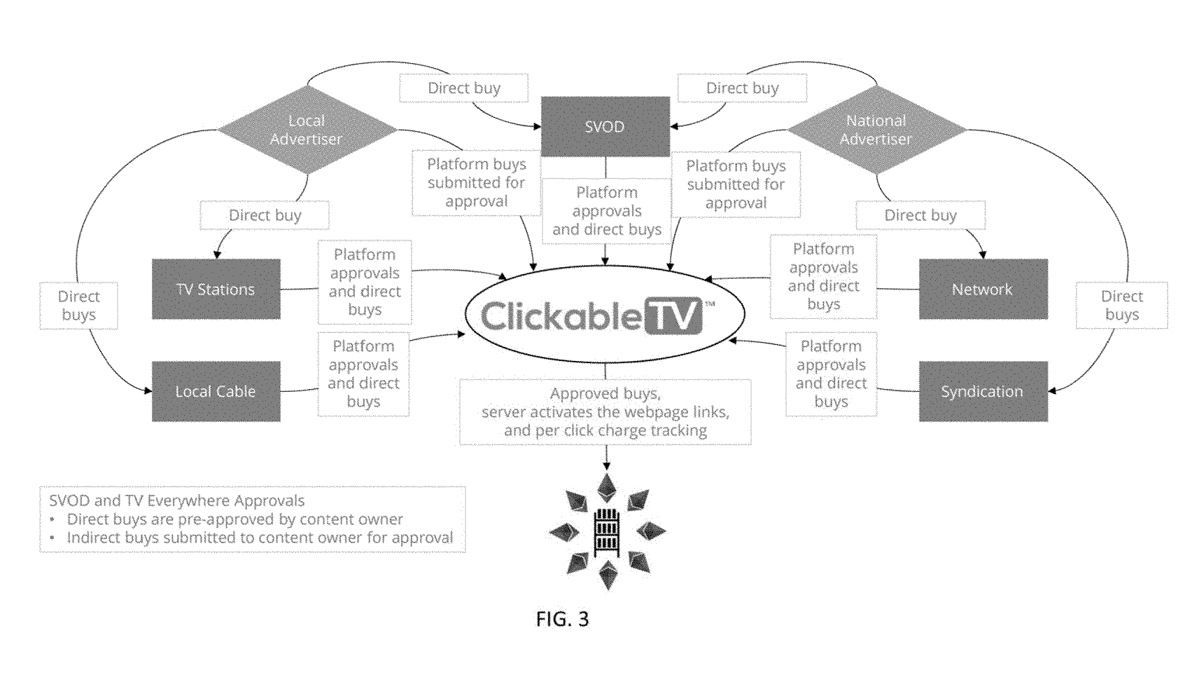

FIG. 3 illustrates an exemplary transaction flow of the proposed system for clickableTV targeting by location and content attributes, in accordance with an exemplary embodiment of the present disclosure.

In an exemplary embodiment, every media outlet, and television show, owns the intellectual property rights to the television commercial slots contained within their programming. In certain circumstances the networks, and shows, may sublease these rights to MVPD providers and networks. In other words copyright holders may retain a portion of their commercial inventory for their own use while also subleasing a portion out to third parties for some financial benefit.

The ClickableTV media buying application was designed in such a way as to get approval for enhancement enablement from both the primary copyright owner as well as any sublease holder.

In an exemplary embodiment, once the enhanced media buy is approved by all parties it is transferred to the ClickableTV in order to enable the enhancements by the ClickableTV server.

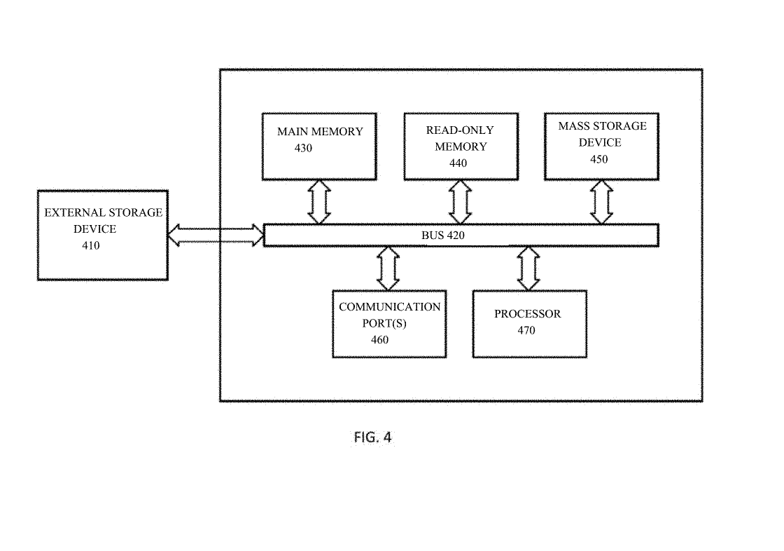

FIG. 4 illustrates an exemplary computer system 400 in which or with which embodiments of the present invention may be utilized.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown in the figure, computer system 400 includes an external storage device 410, a bus 420, a main memory 430, a read only memory 440, a mass storage device 450, communication port 460, and a processor 470.

### Electronic Device

In some embodiments, the platforms, media, methods and applications described herein include an electronic device, a processor, or use of the same. In further embodiments, the electronic device includes one or more hardware central processing units (CPU) that carry out the device's functions. In still further embodiments, the electronic device further comprises an operating system configured to perform executable instructions. In some embodiments, the electronic device is optionally connected a computer network. In further embodiments, the electronic device is optionally connected to the Internet such that it accesses the World Wide Web. In still further embodiments, the electronic device is optionally connected to a cloud computing infrastructure. In other embodiments, the electronic device is optionally connected to an intranet. In other embodiments, the electronic device is optionally connected to a data storage device. In accordance with the description herein, suitable electronic devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the electronic device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the electronic device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In some embodiments, the non-volatile memory comprises magneto-resistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the electronic device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the electronic device includes an input device to receive information from a subject. In some embodiments, the input device is a keyboard. In some embodiments, the input device is a pointing device including, by way of non-limiting examples, a mouse, trackball, trackpad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of an electronic device. In still further embodiments, a computer readable storage medium is optionally removable from an electronic device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiment, the platforms, media, methods and applications described herein include at least one computer program, or use of the same. A computer program includes a sequence of instructions, executable in the electronic device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, MySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tel, Smalltalk, WebDNA®' or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile electronic device. In some embodiments, the mobile application is provided to a mobile electronic device at the time it is manufactured. In other embodiments, the mobile application is provided to a mobile electronic device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof Compilation is often performed, at least in part, to create an executable program. In some embodiments, a computer program includes one or more executable compiled applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected electronic devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile electronic devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

What is claimed is:

1. A computer-implemented method comprising:
receiving an input requesting an advertisement for inclusion in a particular web page of a plurality of web pages that collectively represent a website, wherein the input further comprising at least attribute information provided by an advertiser of the advertisement;
retrieving, upon clicking of the advertisement embedded in the particular web page, one or more web links that enables the user to view an advertised product;
determining one or more interaction events performed by the user while viewing the advertised product;
generating a registration entry associated with the one or more interaction events.

2. The computer-implemented method of claim 1, wherein the attribute information specifies a specific criteria for advertisement, the specific criteria comprising: locations, countries, media outlets, shows, actors, age groups, community, gender, genre, type of advertisement, income group, status, cable network lists, show lists, market lists, MVPD lists, and network lists and time of a day.

3. The computer-implemented method of claim 1, wherein further comprising displaying the particular web page with the selected advertisement on a device at a network location.

4. The computer-implemented method of claim 1, wherein the advertisements are embedded in the form of one or more clickable moments, and wherein the attribute information is associated with one or more clickable moments.

5. The computer-implemented method of claim 1, wherein the at least attribute information provided by the advertiser of the advertisement is indicative of a targeted advertising.

6. The computer-implemented method of claim 1, wherein the advertiser pay's only for clicks or revenue-sharing according to agreements pre-defined.

7. The computer-implemented method of claim 1, wherein the clicking of the advertisement enables retailing of the advertised product.

8. The computer-implemented method of claim 1, wherein the registration entry is preferably stored on decentralized blockchain ledgers.

9. The computer-implemented method of claim 1, wherein the registration entry is generated based on the one or more interaction events.

10. The computer-implemented method of claim 1, wherein the registration entry is secured using a combination of one or more tokens and one or more encryption keys ensuring privacy and security of the user's data and an advertiser's data.

11. The computer-implemented method of claim 1, wherein the advertisement enables the user to request information associated with the advertised product from the advertiser.

12. The computer-implemented method of claim 1, wherein the advertisement embedded in the particular web page is configured to operate in a LIVE environment and/or a desktop virtual reality (DVR) environment.

13. The computer-implemented method of claim 1, wherein the one or more interaction events are associated with at least a click stream data.

14. The computer-implemented method of claim 1, wherein the one or more interaction events are associated with at least an e-commerce sales data.

15. A system, comprising:
one or more computers and one or more storage devices storing instructions that are operable, when executed by the one or more computers, to cause the one or more computers to perform operations comprising:
receiving an input requesting an advertisement for inclusion in a particular web page of a plurality of web pages that collectively represent a website, wherein the input further comprising at least attribute information provided by an advertiser of the advertisement;
retrieving, upon clicking of the advertisement embedded in the particular web page, one or more web links that enables the user to view an advertised product;
determining one or more interaction events performed by the user while viewing the advertised product;
generating a registration entry associated with the one or more interaction events.

16. The system of claim 15, wherein the attribute information specifies a specific criteria for advertisement, the specific criteria comprising: locations, countries, media outlets, shows, actors, age groups, community, gender, genre, type of advertisement, income group, status, cable network lists, show lists, market lists, MVPD lists, and network lists and time of a day.

17. The system of claim 15, wherein further comprises displaying the particular web page with the selected advertisement on a device at a network location.

18. The system of claim 15, wherein the advertisements are embedded in the form of one or more clickable moments, and wherein the attribute information is associated with one or more clickable moments.

19. The system of claim 15, wherein the at least attribute information provided by the advertiser of the advertisement is indicative of a targeted advertising.

20. The system of claim 15, wherein the advertiser pay's only for clicks or revenue-sharing according to agreements pre-defined.

21. The system of claim 15, wherein the clicking of the advertisement enables retailing of the advertised product.

22. The system of claim 15, wherein the registration entry is preferably stored on decentralized blockchain ledgers.

23. The system of claim 15, wherein the registration entry is generated based on the one or more interaction events.

24. The system of claim 15, wherein the registration entry is secured using a combination of one or more tokens and one or more encryption keys ensuring privacy and security of the user's data and an advertiser's data.

25. The system of claim 15, wherein the advertisement enables the user to request information associated with the advertised product from the advertiser.

26. The system of claim 15, wherein the advertisement embedded in the particular web page is configured to operate in a LIVE environment and/or a desktop virtual reality (DVR) environment.

27. The system of claim 15, wherein the one or more interaction events are associated with at least a click stream data.

28. The system of claim 15, wherein the one or more interaction events are associated with at least an e-commerce sales data.

29. A non-transitory computer-readable medium storing software comprising instructions executable by one or more computers which, upon such execution, cause the one or more computers to perform operations comprising:
receiving an input requesting an advertisement for inclusion in a particular web page of a plurality of web pages that collectively represent a website, wherein the input further comprising at least attribute information provided by an advertiser of the advertisement;
retrieving, upon clicking of the advertisement embedded in the particular web page, one or more web links that enables the user to view an advertised product;
determining one or more interaction events performed by the user while viewing the advertised product;
generating a registration entry associated with the one or more interaction events.
